(19) United States
(12) Patent Application Publication
(10) Pub. No.: US 2006/0096406 A1
(43) Pub. Date: May 11, 2006

(54) Gear lever having a light emitting effect

(76) Inventor: Yao-Huang Liu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/983,296

(22) Filed: Nov. 8, 2004

(51) Int. Cl. G05G 1/10

(52) U.S. Cl. 74/543

(57) ABSTRACT

A gear lever for a car gear lever includes a main body, a top cover mounted on the main body, a light-gathering member mounted between the main body and the top cover, and a circuit board mounted between the main body and the light-gathering member and provided with a light emitting member directed toward the light-gathering member. Thus, the light rays emitted from the light emitting member are gathered in the light-gathering member and are emitted outward from the transparent flange of the light-gathering member and the through holes of the top cover, thereby enhancing the outstanding appearance of the gear lever.

### BACKGROUND OF THE INVENTION

1. Field of the Invention

The present invention relates to a gear lever for a car, and more particularly to a gear lever having a light emitting effect.

2. Description of the Related Art

A conventional gear lever 1 for a car in accordance with the prior art shown in FIGS. 4 and 5 comprises a main body 10 having an upper end formed with a recess 100 and an inner thread 101, a top cover 12 mounted on the main body 10 and having a lower end formed with an outer thread 121 screwed into the inner thread 101 of the main body 10 and an upper end formed with a transparent face 120, and a circuit board 11 mounted between the main body 10 and the top cover 12 and having a first side provided with a light emitting member 110 and a second side provided with an electric wire 111 connected to a wire contained in the car. When an electric power of the car is supplied to the electric wire 111, the light emitting member 110 lights and the light rays from the light emitting member 10 are emitted outward from the transparent face 120 of the top cover 12, thereby enhancing the outstanding appearance of the gear lever 1. However, the electric wire 111 of the circuit board 11 is connected to the wire contained in the car, so that a user cannot replace the circuit board 11 easily and conveniently when the circuit board 1 is worn out during a long-term utilization.

Another conventional gear lever 2 for a car in accordance with the prior art shown in FIGS. 6 and 7 comprises a main body 20 having an upper end formed with a recess 200 and an inner thread 201, a top cover 22 mounted on the main body 20 and having a lower end formed with an outer thread 221 screwed into the inner thread 201 of the main body 20 and a peripheral wall formed with a plurality of through holes 220, and a circuit board 21 mounted between the main body 20 and the top cover 22 and having a first side provided with a plurality of light emitting members 210 aligning with the through holes 220 of the top cover 22 and a second side provided with an electric wire 211 connected to a wire contained in the car. When an electric power of the car is supplied to the electric wire 211, the light emitting member 210 light and the light rays from the light emitting members 210 are emitted outward from the through holes 220 of the top cover 22, thereby enhancing the outstanding appearance of the gear lever 2. However, the electric wire 211 of the circuit board 21 is connected to the wire contained in the car, so that a user cannot replace the circuit board 21 easily and conveniently when the circuit board 21 is worn out during a long-term utilization.

### SUMMARY OF THE INVENTION

In accordance with the present invention, there is provided a gear lever, comprising:
a main body;
a top cover mounted on the main body;
a light-gathering member mounted between the main body and the top cover; and
a circuit board mounted between the main body and the light-gathering member and provided with a light emitting member directed toward the light-gathering member.

The primary objective of the present invention is to provide a gear lever having a light emitting effect.

Another objective of the present invention is to provide a gear lever, wherein the light rays emitted from the light emitting member are gathered in the light-gathering member and are emitted outward from the transparent flange of the light-gathering member and the through holes of the top cover, thereby enhancing the outstanding appearance of the gear lever.

A further objective of the present invention is to provide a gear lever, wherein the electric power of the light emitting member is supplied by the batteries of the circuit board, and the circuit board needs not to be connected to the wires contained in the car, so that a user can mount and detach the circuit board easily and conveniently, thereby facilitating the user replacing the circuit board when the circuit board is worn out during a long-term utilization.

A further objective of the present invention is to provide a gear lever, wherein the gear lever only needs to provide a single light emitting member to emit light rays through the transparent flange of the light-gathering member and the through holes of the top cover so as to enhance the outstanding appearance of the gear lever, thereby decreasing costs of the gear lever.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a gear lever in accordance with the preferred embodiment of the present invention;

FIG. 2 is an exploded perspective view of the gear lever as shown in FIG. 1;

FIG. 3 is a plan cross-sectional view of the gear lever as shown in FIG. 1;

FIG. 4 is a perspective view of a conventional gear lever in accordance with the prior art;

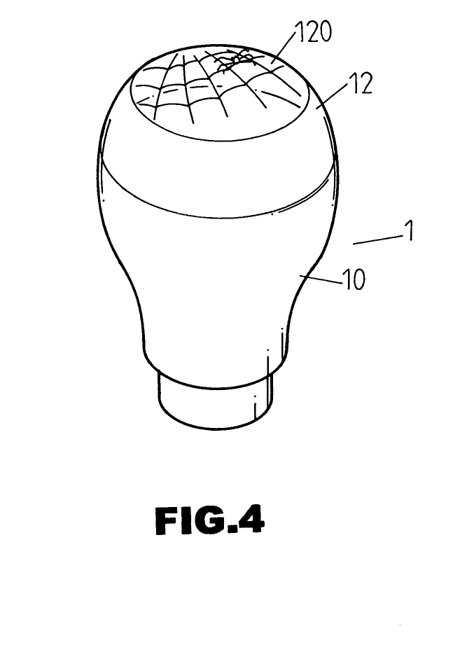

FIG. 5 is an exploded perspective view of the conventional gear lever as shown in FIG. 4;

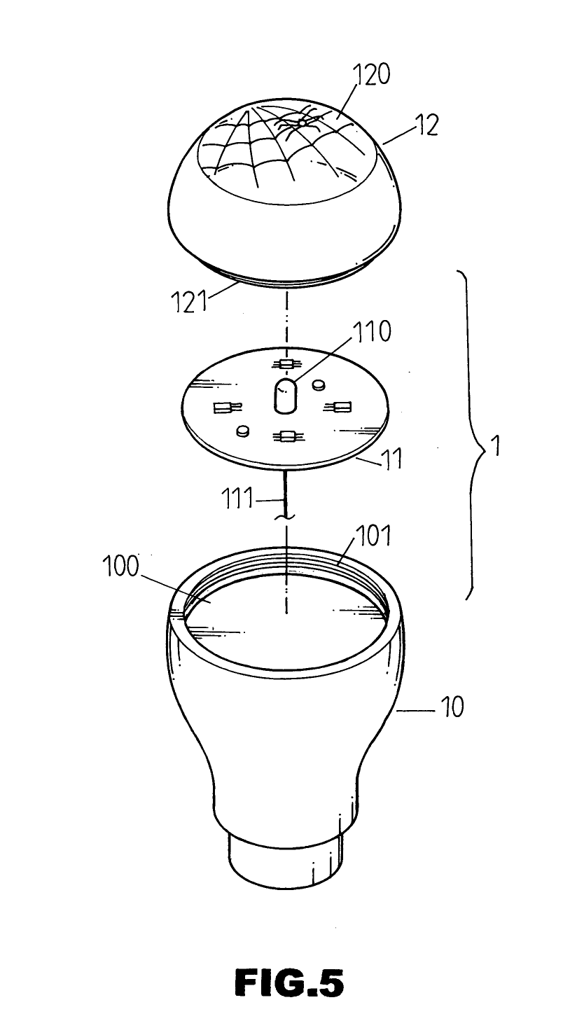

FIG. 6 is a perspective view of another conventional gear lever in accordance with the prior art; and

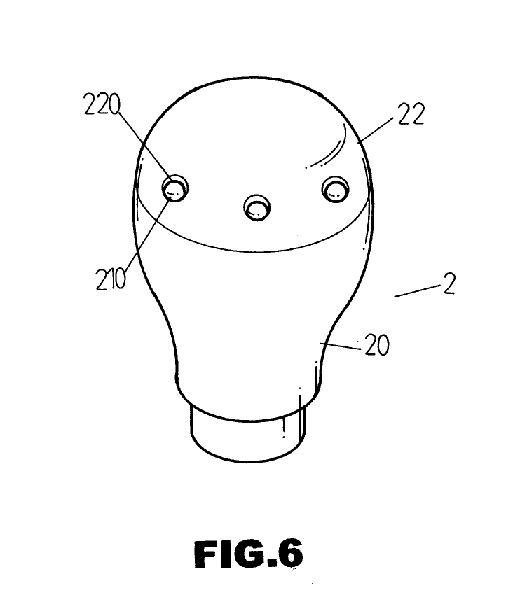

FIG. 7 is an exploded perspective view of the conventional gear lever as shown in FIG. 6.

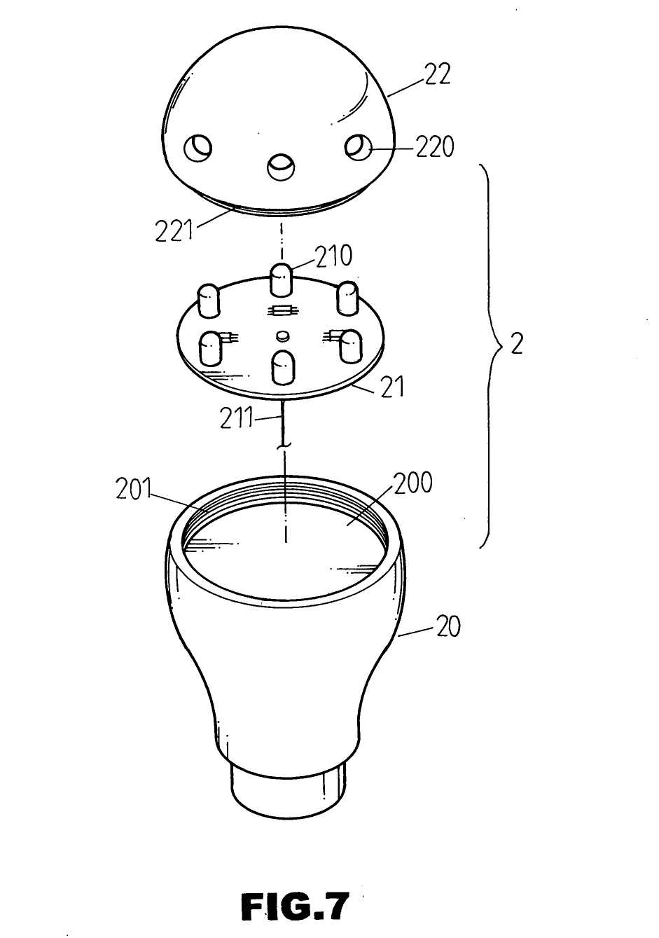

### DETAILED DESCRIPTION OF THE INVENTION

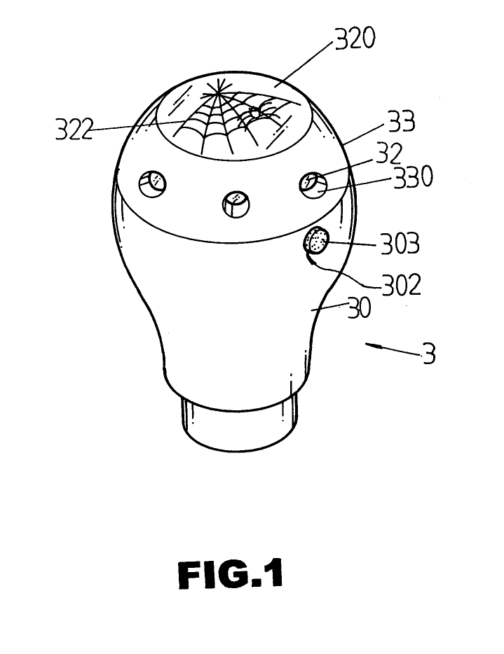

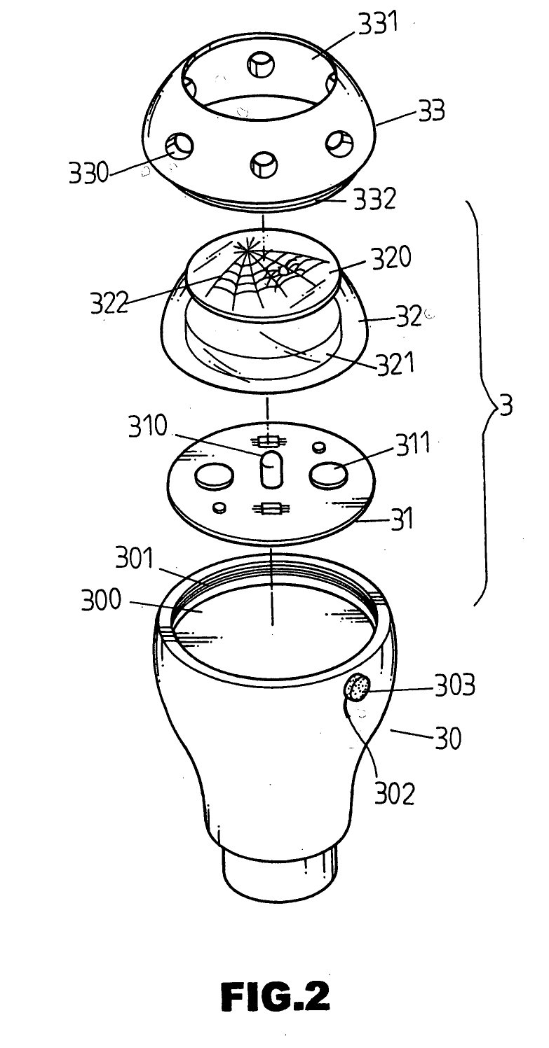

Referring to the drawings and initially to FIGS. 1 and 2, a gear lever 3 for a car in accordance with the preferred embodiment of the present invention comprises a main body 30, a top cover 33 mounted on the main body 30, a light-gathering member 32 mounted between the main body 30 and the top cover 33, and a circuit board 31 mounted between the main body 30 and the light-gathering member 32 and provided with a light emitting member 310 directed toward the light-gathering member 32.

As shown in FIGS. 1-3, the main body 30 has an upper end formed with a recess 300 to receive the circuit board 31 and formed with an inner thread 301. The upper end of the main body 30 has a peripheral wall formed with a mounting hole 302 communicating with the recess 300.

A push button 303 is movably mounted in the mounting hole 302 of the main body 30 to detachably contact with the circuit board 31 to control operation of the light emitting member 310 of the circuit board 31.

The top cover 33 has a lower end formed with an outer thread 332 screwed into the inner thread 301 of the main body 30 and an upper end formed with a circular hole 331. The top cover 33 has a peripheral wall formed with a plurality of through holes 330.

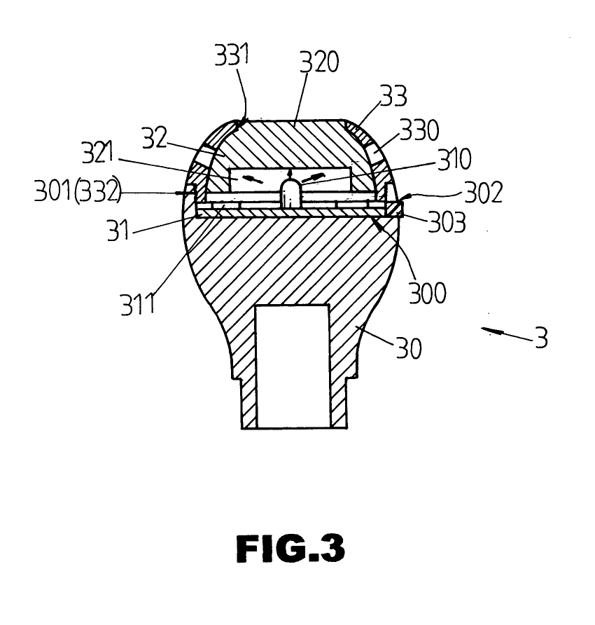

The light-gathering member 32 is flush received in the top cover 33 completely and smoothly. The light-gathering member 32 is a transparent body made of acrylic material and has a shape and a size substantially flush with that of an inside of the top cover 33. The light-gathering member 32 has a top formed with a circular flange 320 flush received in the circular hole 331 of the top cover 33 The flange 320 of the light-gathering member 32 has a top formed with a pattern 322. The light-gathering member 32 has a bottom formed with a circular chamber 321 to receive the light emitting member 310 of the circuit board 31. The light-gathering member 32 has a peripheral wall closing the through holes 330 of the top cover 33 as shown in FIG. 3.

The circuit board 31 has a first side provided with the light emitting member 310 and two batteries 311 and a second side rested on the main body 30.

When in use, as shown in FIG. 3, when the push button 303 is pressed to touch the circuit board 31, the batteries 311 of the circuit board 31 supply an electric power to the light emitting member 310 so as to light the light emitting member 310. At this time, the light rays emitted from the light emitting member 310 are gathered in the light-gathering member 32 and are emitted outward from the flange 320 of the light-gathering member 32 and the through holes 330 of the top cover 33, thereby enhancing the outstanding appearance of the gear lever 3.

Accordingly, the light rays emitted from the light emitting member 310 are gathered in the light-gathering member 32 and are emitted outward from the transparent flange 320 of the light-gathering member 32 and the through holes 330 of the top cover 33, thereby enhancing the outstanding appearance of the gear lever 3. In addition, the electric power of the light emitting member 310 is supplied by the batteries 311 of the circuit board 31, and the circuit board 31 needs not to be connected to the wires contained in the car, so that a user can mount and detach the circuit board 31 easily and conveniently, thereby facilitating the user replacing the circuit board 31 when the circuit board 31 is worn out during a long-term utilization. Further, the gear lever 3 only needs to provide a single light emitting member 310 to emit light rays through the transparent flange 320 of the light-gathering member 32 and the through holes 330 of the top cover 33 so as to enhance the outstanding appearance of the gear lever 3, thereby decreasing costs of the gear lever 3.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A gear lever, comprising:
a main body;
a top cover mounted on the main body;
a light-gathering member mounted between the main body and the top cover; and
a circuit board mounted between the main body and the light-gathering member and provided with a light emitting member directed toward the light-gathering member.

2. The gear lever in accordance with claim 1, wherein the light-gathering member is flush received in the top cover completely and smoothly.

3. The gear lever in accordance with claim 1, wherein the light-gathering member is a transparent body.

4. The gear lever in accordance with claim 1, wherein the light-gathering member has a shape and a size substantially flush with that of an inside of the top cover.

5. The gear lever in accordance with claim 1, wherein the top cover has an upper end formed with a circular hole, and the light-gathering member has a top formed with a circular flange flush received in the circular hole of the top cover.

6. The gear lever in accordance with claim 5, wherein the flange of the light-gathering member has a top formed with a pattern.

7. The gear lever in accordance with claim 1, wherein the light-gathering member has a bottom formed with a circular chamber to receive the light emitting member of the circuit board.

8. The gear lever in accordance with claim 1, wherein the top cover has a peripheral wall formed with a plurality of through holes, and the light-gathering member has a peripheral wall closing the through holes of the top cover.

9. The gear lever in accordance with claim 1, wherein the circuit board has a first side provided with the light emitting member and two batteries and a second side rested on the main body.

10. The gear lever in accordance with claim 1, wherein the upper end of the main body has a peripheral wall formed with a mounting hole communicating with the recess, and the gear lever further comprises a push button movably mounted in the mounting hole of the main body to detachably contact with the circuit board to control operation of the light emitting member of the circuit board.

11. The gear lever in accordance with claim 10, wherein when the push button is pressed to touch the circuit board, the circuit board supplies an electric power to the light emitting member so as to light the light emitting member.

12. The gear lever in accordance with claim 1, wherein the main body has an upper end formed with a recess to receive the circuit board.

13. The gear lever in accordance with claim 1, wherein the main body has an upper end formed with formed with an inner thread, and the top cover has a lower end formed with an outer thread screwed into the inner thread of the main body.

14. The gear lever in accordance with claim 8, wherein light rays emitted from the light emitting member are gathered in the light-gathering member and are emitted outward from the light-gathering member and the through holes of the top cover simultaneously.
